(19) United States
(12) Patent Application Publication
(10) Pub. No.: US 2004/0169815 A1
(43) Pub. Date: Sep. 2, 2004

(54) Novel system for mounting sidearms on spectacles

(76) Inventor: Francois Lambert, Marseille (FR)

Correspondence Address: BROWDY AND NEIMARK, P.L.L.C., 624 NINTH STREET, NW, SUITE 300, WASHINGTON, DC, 20001-5303, US

(21) Appl. No.: 10/481,643

(22) PCT Filed: Jun. 20, 2002
(86) PCT No.: PCT/FR02/02150

(30) Foreign Application Priority Data
Jun. 21, 2001 (FR) 01/08153

(51) Int. Cl. G02C 5/00

(52) U.S. Cl. 351/140

(57) ABSTRACT

A rimless spectacle side arm mounting system, comprising a screw (2) installed approximately horizontally and approximately parallel to the “plane” of a lens (1), the thread of which is pointing to the outer edge of the lens (1), is free to cooperate with a nut (18) and is proud of the edge of the lens (1), a pair of spectacles comprising such a mounting system and a cord (20, 21) spectacle side arm, comprising a nut (18) in the form of an internally threaded dowel, one end of which is practically closed whilst still leaving room for the cord (20, 21) to pass through, the end of which on the side of the dowel (18) has a wider part to lock it in the dowel (18) whilst still leaving the dowel free to rotate.

This invention relates to a novel spectacle side arm mounting system and spectacles fitted with such a system.

In the field of spectacle making, aesthetic issues are a constant preoccupation. Increasingly, spectacle-wearers use several different pairs depending on the circumstances, for example for work, sport, going out in the evening, etc.

After lengthy research, the applicant has discovered a novel spectacle side arm mounting system that is aesthetic and allows for the spectacle side arms to be changed at will, easily and without tools.

Furthermore, this system allows for cord side arms to be fitted.

In this document, the positions of the components are given with reference to normal wear of the spectacles on the face of the spectacle-wearer in a standing position.

A subject of this invention is a novel spectacle side arm mounting system, and spectacles or spectacle components equipped with such a mounting system.

The first subject of the present invention is therefore spectacles characterised in that they comprise a spectacle side arm mounting system comprising a side arm mounting screw installed approximately horizontally and approximately parallel to the plane of a lens, the thread of which is pointing to the outer edge of the lens and is free to cooperate with a nut.

Under preferred conditions for implementing the invention, the thread on the side arm mounting screw pointing to the outer edge of the lens is proud of the edge of the frame, or the edge of the lens on rimless spectacles. The protrusion may for example be between 1 and 10 mm, and in particular between 2 and 8 mm, and most particularly between 3 and 6 mm.

In the present invention, by “side arm” is meant both a “conventional” rigid or semi-rigid side arm (that is, one that can be bent without breaking) and a cord side arm. By “rimless spectacles” is meant spectacles on which the side arms are mounted directly on the lens, with part rims or no rims.

Under preferred conditions for implementing the invention, the side arm mounting screw is diametrically split over at least part of its length for reasons given below, and the slit is preferably horizontal.

Under other preferred conditions for implementing the invention, the mounting system above also comprises a second screw known as the “lens mounting screw” installed approximately at a right angle with respect to the side arm mounting screw and perpendicular to the lens.

The second screw can be used to mount the system directly on the spectacle lens.

The mounting system above preferably comprises a pin installed approximately parallel to the lens mounting screw, to cooperate with a notch provided in the edge of the lens or with a hole made by piercing the lens. The mounting system is thus held in position and cannot rotate.

The side arm mounting screw is advantageously diametrically pierced as will be seen below.

It is preferably in the form of two coaxial cylinders with different diameters, the cylinder with the smallest diameter being threaded to form the screw, whilst the second screw is advantageously fixed to the cylinder with the larger diameter. The cylinder with the largest diameter may be truncated so that it is flat against the lens, which demonstrates that this cylindrical shape is purely optional.

The side arm mounting screw and the second screw may form a single part. In this case, the two screws may for example be soldered perpendicularly to each other, preferably to form an L-shape.

They may be separate. In this case, the side arm mounting screw is diametrically pierced to allow the second screw to pass through, and they are preferably mounted at right angles. The side arm mounting screw may be installed in front of or behind the lens.

Under preferred conditions for implementation, the two screws are mounted one at the end of the other.

The side arm mounting screw is used to mount a particular type of side arm. Said side arm comprises a nut that is mounted rotating freely relative to the side arm and said nut is designed to cooperate with the thread on the side arm mounting screw.

In a first preferred configuration, the side arm is a cord side arm, that is, comprising a cord or principally made up of a cord made of for example polyester, nylon or metal with a diameter smaller than 0.3 mm, that is, behaving almost like a textile, elastomer or rubber cord, i.e. extendible. The cord side arm therefore joins one spectacle lens to the other around the head. In this case, the nut may be in the form of an internally threaded dowel, one end of which is practically closed whilst still leaving room for the cord to pass through, the end of which on the dowel side has a wider part to lock it in the dowel whilst still leaving the dowel free to rotate. An elastic cord side arm is particularly suitable for sports if it holds the spectacles firmly against the face.

A rigid or semi-rigid type side arm part may advantageously be combined with a cord type side arm, particularly extendible. The rigid or semi-rigid side arm part may be between two cord parts, and in this case it is advantageously curved to fit around the head or neck or vice versa.

In another preferred configuration, the side arm is rigid or semi-rigid, that is, conventional. The central axis of the nut is then preferably installed perpendicular to the side arm. The end of the side arm on the side of the spectacles advantageously comprises two right-angled extensions, with the nut installed at the level of the first extension.

The right-angled extensions are preferably constituted by a rigid or semi-rigid metal cord. Under preferred conditions for implementation, the entire side arm is constituted by a cord, for example made of metal, in particular approximately 1 mm in diameter, which considerably simplifies the production of the side arm, which is preferably titanium. Obviously, part of the cord may be sheathed, for example around the ears.

Under other preferred conditions for implementation, the length of the first extension is approximately the same as the length of the dowel forming the nut.

Under further preferred conditions for implementation, the length of the second extension is approximately 0.5 to 8 mm, advantageously between 0.5 and 5 mm, preferably between 1 and 5 mm, and in particular between 1 and 3 mm.

A spectacle side arm can be installed very easily on a side arm mounting system according to the invention.

For a cord side arm, the internally threaded dowel must simply be screwed onto the side arm mounting screw. In the case of a rigid or semi-rigid side arm, the second extension must simply be inserted into the slit in the second screw described above and the dowel must be screwed on the mounting screw. It will be clear to a person skilled in the art that the slit and the second extension must be oriented so that the spectacle side arm is installed horizontally.

Under other preferred conditions for implementing the invention, the nut is externally cylindrical, which makes it easier for the spectacle-wearer to screw and unscrew by hand, without tools.

To prevent the fingers slipping during screwing or unscrewing, the outer surface of the nut advantageously has a non-slip coating, for example through the installation of pyramid teeth or other projections.

Under further preferred conditions for implementing the invention, the outer diameter of the nut is approximately identical to or slightly larger than the diameter of the cylinder with the largest diameter in the screw when such a cylinder is provided, to make it easier to unscrew without being hindered by said screw.

Under further preferred conditions for implementing the invention, the spectacle side arm mounting system according to the present invention also comprises a protrusion opposite the spectacle lens mounting screw. This protrusion may be cylindrical, but is advantageously ovoid.

It allows for a shade, for example a tinted shade, to be mounted on a pair of spectacles.

Such shade is for example constituted by a plastic film such as cellulose acetate, the shape of which approximately follows the shape of the lenses, said shade comprising lateral holes that are the same distance apart as the protrusions and allow for the protrusions to pass through and be immobilised.

The holes and the protrusions thus must simply be aligned and the shade pushed down towards the lenses to obtain for example sunglasses, the mounting of which is not hindered by any device as it uses the existing device for mounting the lenses and their side arms.

A subject of the present invention is also the novel spectacle side arm mounting system described above.

A subject of the present invention is therefore a novel spectacle side arm mounting system, in particular for rimless spectacles, characterised in that it comprises a screw installed approximately horizontally and approximately parallel to the “plane” of a lens, on which the thread points to the outer edge of the lens, is free to cooperate with a nut and is proud of the edge of the lens.

Finally, a subject of the present invention is a spectacle side arm, characterised in that it is of a rigid or semi-rigid type, in that its end on the side of the spectacles comprises two right-angled extensions, a nut mounted rotating freely around the side arm being installed at the level of the first extension, and in that the central axis of the nut is installed perpendicular to the length of the side arm, together with a spectacle side arm, characterised in that it is made of cord and comprises a nut in the form of an internally threaded dowel, one end of which is practically closed, whilst still leaving room for the cord to pass through, the end of which on the side of the dowel has a wider part to lock it in the dowel, whilst still leaving the dowel free to rotate.

The spectacles covered by this invention have very useful qualities.

The wearer of the spectacles according to the invention may in particular change the side arm system at will depending on the activity he is engaged in. He can thus have spectacles with a frame that is perfectly suited to all circumstances and locations.

Similarly, the side arms can be changed at any time by the spectacle user, who can thus have several frames for a single set of lenses, without any dismantling equipment.

The preferred embodiments conditions for the implementation of the pairs of spectacles described above also apply to other subjects of the invention set out above, and in particular to the mounting systems and spectacle side arms according to the invention.

The invention will be better understood by reference to the appended drawings, in which:

FIG. 1 shows a cross-section of a lens level with a spectacle side arm mounting system according to the invention, made of a single part directly mounted onto a lens.

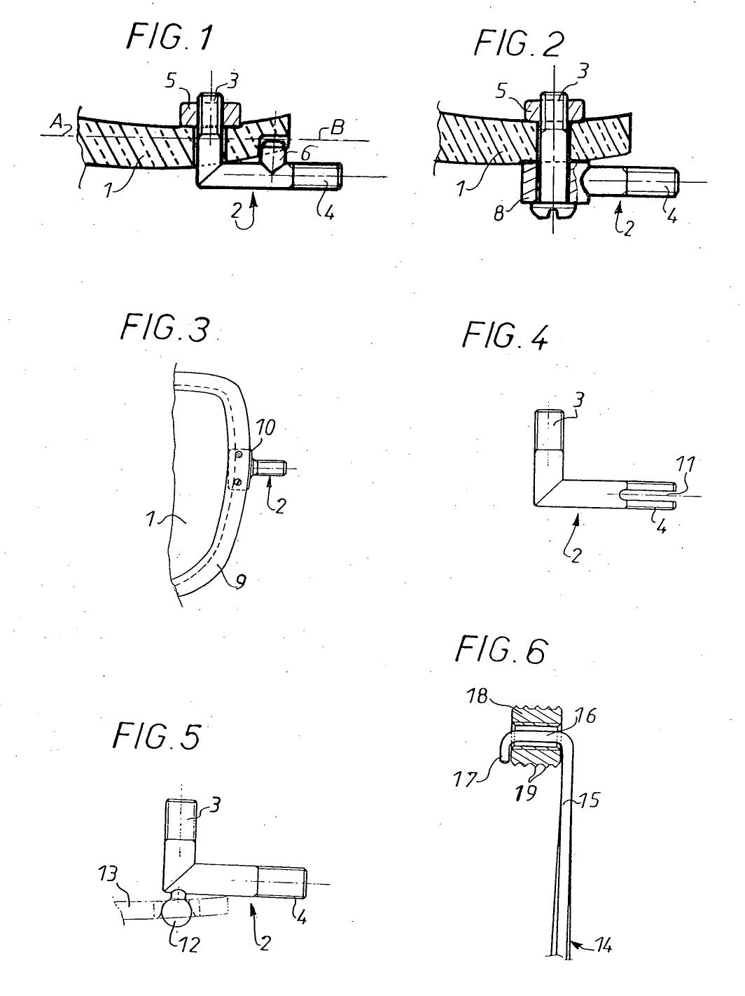

FIG. 2 shows a cross-section of a lens level with a spectacle side arm mounting system according to the invention, made of two parts directly mounted onto a lens.

FIG. 3 is a front view of part of a frame fitted with a spectacle side arm mounting system according to the invention.

FIG. 4 is a variant of the screw in FIG. 1, in which the side arm mounting screw is diametrically split over part of its length and does not comprise a pin.

FIG. 5 is a variant of the screw in FIG. 1, in which the side arm mounting screw comprises a protrusion allowing for a shade to be mounted on the pair of spectacles.

FIG. 6 shows a side arm essentially constituted by a flexible (semi-rigid) metal cord.

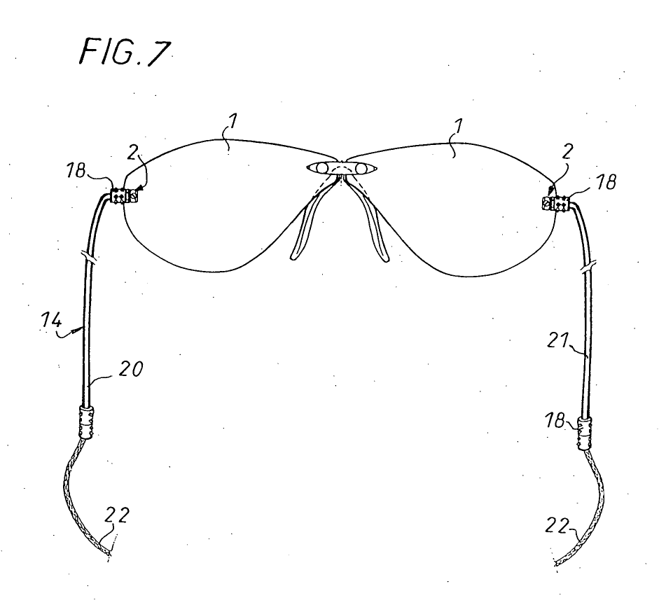

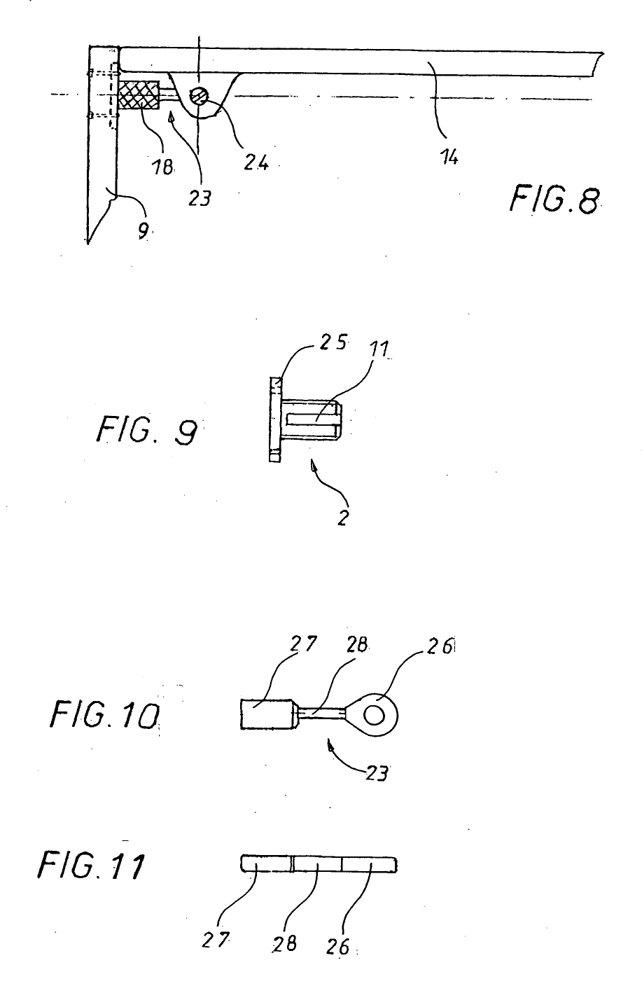

FIG. 7 shows a pair of spectacles on which the side arms are essentially made up of a textile cord.

FIG. 1 shows a lens 1 laterally comprising a spectacle side arm mounting system according to the invention made of a single part directly mounted onto a lens. The screw is essentially L-shaped and the two ends are threaded. The system is constituted by a side arm mounting screw 2 and a second lens mounting screw 3. The side arm mounting screw 2 is installed approximately horizontally and approximately parallel to the “plane” of a lens shown by AB. Its thread 4 is pointing to the outer edge of the lens, and is free to cooperate with a nut. It is in fact proud of the edge of the lens.

The mounting system shown also comprises a second screw 3 installed approximately at a right angle with respect to the side arm mounting screw 2 and perpendicular to the lens 1. This second screw 3 passes through the lens 1 and is held by a conventional nut 5.

The system also comprises a pin 6 installed approximately parallel to the lens 1 mounting screw 3, to cooperate with a notch 7 made in the edge of the lens 1. The mounting system is thus held in position and cannot rotate.

FIG. 2 shows the mounting of a two-part system. The screws 2 and 3 are, in fact, separate parts. The side arm mounting screw 2 is radially pierced to allow the lens 1 mounting screw 3 to pass through. This screw 3 has a conventional structure. It has an unthreaded cylindrical end 8 that is wider relative to the diameter of the thread.

FIG. 3 shows a conventional rimmed frame 9. The side arm mounting part 10 is equipped with a side arm mounting screw 2 that is proud of the edge of the frame 9.

FIG. 4 is a variant of FIG. 1 in which the side arm mounting screw 2 is diametrically split 11 over part of its length to cooperate more effectively with the side arm shown in FIG. 6.

FIG. 5 is another variant of FIG. 1 in which the side arm mounting screw 2 comprises a protrusion 12 in the shape of a ball, allowing for a shade 13 made of a tinted film 0.5 to 1 mm thick to be mounted onto the pair of spectacles, the shape of which follows the shape of the lenses and which is pierced at the level of the protrusions 12 so that it can be pushed down and thus be immobilised and remain flat against the lenses.

FIG. 6 shows the end situated on the side of the lenses of a side arm 14 essentially constituted by a flexible, that is, semi-rigid, metal cord 15, made of titanium, 1 mm in diameter and sheathed in plastic.

The end of the side arm on the side of the spectacles comprises two right-angled extensions 16, 17. An internally threaded nut 18 in the form of a dowel is installed at the level of the first extension 16. The first extension 16 is approximately the same length as the dowel 18 forming the nut, which locks the dowel longitudinally. The diameter of the metal cord 15 is smaller than the diameter of the thread to allow the dowel 18 to rotate freely around the metal cord 15.

The second extension 17 is approximately 4 mm long.

A spectacle side arm can be installed very easily on a side arm mounting system according to the invention. The second extension 17 must simply be inserted into the slit 11 in the side arm mounting screw 2 shown in FIG. 4, the dowel 18 and the side arm mounting screw 2 must be aligned and finally the dowel 18 must be screwed onto the mounting screw 2. It can be seen that the slit 11 is oriented so that the second extension 17 on the spectacle side arm 14 should be installed perpendicular to the plane formed by the first extension 16 and the side arm 14 so that the side arm is in a normal horizontal position.

It can further be seen that the nut 18 is externally cylindrical, which makes it easier for the spectacle-wearer to screw and unscrew by hand, without tools. Its outer surface comprises pyramid teeth 19.

The outer diameter of the dowel 18 is approximately identical to or slightly larger than the diameter of the unthreaded cylindrical end 8 to make it easier to unscrew it without being hindered by the screw 2. This characteristic is also aesthetic, which is important for spectacles.

FIG. 7 shows a pair of spectacles on which the side arms 14 are essentially made up of textile cords 20, 21, that may for example be decorated by threading pearls onto them. A third elastic cord 22 is provided. The dowels 18 are mounted rotating freely on the textile cords 20, 21 so that they can be screwed to the side arm mounting screws 2. It must also be noted that given the possibility of twisting the cords, it is not vital for the dowels 18 to be mounted rotating freely. The in-line mounting of the three cords follows the same principle as a bolt. It can be seen that the outer diameter of the dowels 18 is identical to the diameter of the unthreaded part of the screws with which they cooperate, which also provides an excellent aesthetic effect.

1. A pair of spectacles characterised in that it comprises a spectacle side arm mounting system comprising a side arm (14) mounting screw (2) installed approximately horizontally and approximately parallel to the “plane” of a lens (1), the thread (4) on which points to the outer edge of the lens and is free to cooperate with a nut (18).

2. A pair of spectacles according to claim 1, characterised in that the thread (4) on the side arm mounting screw (2) pointing to the outer edge of the lens (1) is proud of the edge of the frame, or the edge of the lens (1) for rimless spectacles.

3. A pair of spectacles according to claim 1 or 2, characterised in that the side arms (14) are of a rigid or semi-rigid type.

4. A pair of spectacles according to claim 1 or 2, characterised in that the side arms (14) are made of cord.

5. A pair of spectacles according to any one of claims 1 to 4, characterised in that the side arm mounting screw (2) is diametrically split (11) over at least part of its length.

6. A pair of spectacles according to claim 5, characterised in that the slit (11) is horizontal.

7. A pair of spectacles according to any one of claims 1 to 6, characterised in that the mounting system comprises a second screw (3) known as the “lens mounting screw”, installed approximately at a right angle with respect to the side arm mounting screw (2) and perpendicular to the lens (1).

8. A pair of spectacles according to claim 7, characterised in that the mounting system also comprises a pin (6) installed approximately parallel to the lens (1) mounting screw (2), to cooperate with a notch (7) made in the edge of the lens (1) or with a hole made by piercing the lens.

9. A pair of spectacles according to any one of claims 1 to 8, characterised in that the side arm mounting screw (2) is diametrically pierced.

10. A pair of spectacles according to any one of claims 7 to 9, characterised in that the side arm mounting screw (2) and the second screw (3) form a single part.

11. A pair of spectacles according to any one of claims 1 to 10, characterised in that the side arms (14) comprise a nut (18) mounted rotating freely relative to the side arm (14), said nut (18) being designed to cooperate with the thread (4) on the side arm mounting screw (2).

12. A pair of spectacles according to claim 11, characterised in that the side arms (14) are made of cord and the nut (18) is in the form of an internally threaded dowel, one end of which is practically closed whilst still leaving room for the cord (20, 21) to pass through, the end of which on the side of the dowel has a wider part to lock it in said dowel (18) whilst still leaving the dowel free to rotate.

13. A pair of spectacles according to any one of claims 1 to 10, characterised in that the side arms (14) are rigid or semi-rigid and the end of the side arm (14) on the side of the spectacles comprises two right-angled extensions (16, 17), the nut (18) being installed at the level of the first extension (16) and its central axis being installed perpendicular to the side arm (14).

14. A pair of spectacles according to any one of claims 1 to 13, characterised in that the whole of one side arm (14) is made up of a metal cord (15), part of which may be sheathed.

15. A pair of spectacles according to claim 13 or 14, characterised in that the first extension (16) is approximately the same length as the dowel (18) forming the nut.

16. A rimless spectacle side arm mounting system, characterised in that it comprises a screw (2) installed approximately horizontally and approximately parallel to the “plane” of a lens (1), the thread on which is pointing to the outer edge of the lens (1), is free to cooperate with a nut (18) and is proud of the edge of the lens (1).

17. A spectacle side arm, characterised in that it is made of cord (20, 21) and in that it comprises a nut (18) in the form of an internally threaded dowel, one end of which is practically closed whilst still leaving room for the cord (20, 21) to pass through, the end of which on the side of the dowel (18) has a wider part to lock it in the dowel (18) whilst still leaving the dowel free to rotate.

18. A spectacle side arm, characterised in that it is of a rigid or semi-rigid type (14), its end on the side of the spectacles comprises two right-angled extensions (16, 17), a nut (18) mounted rotating freely around the side arm (14) being installed at the level of the first extension (16), and the central axis of the nut (18) is installed perpendicular to the length of the side arm (14).
